(19) United States
(12) Patent Application Publication
(10) Pub. No.: US 2016/0357819 A1
(43) Pub. Date: Dec. 8, 2016

(54) EFFICIENT MEANS FOR IDENTIFYING COMMON SUBSEQUENCES USING A TIER SET

(71) Applicant: Richard Salisbury, Austin, TX (US)

(72) Inventor: Richard Salisbury, Austin, TX (US)

(21) Appl. No.: 15/243,719

(22) Filed: Aug. 22, 2016

Related U.S. Application Data
(63) Continuation-in-part of application No. 14/924,425, filed on Oct. 27, 2015.
(60) Provisional application No. 62/208,691, filed on Aug. 22, 2015.
(60) Provisional application No. 62/073,128, filed on Oct. 31, 2014.
(60) Provisional application No. 62/083,842, filed on Nov. 24, 2014.
(60) Provisional application No. 62/170,095, filed on Jun. 2, 2015.

(51) Int. Cl. G06F 17/30

(52) U.S. Cl. CPC G06F 17/30477; G06F 17/30333

(57) ABSTRACT

A method of identifying one or more common subsequences using a tier set. The method includes identifying one or more qualifying tier pairs in a tier set and identifying one or more pairwise combinations of location n-tuples in the qualifying tier pairs. The method also includes determining which of the identified pairwise combinations are qualifying location n-tuple pairs and determining whether a connection exists between the lower location n-tuple and the upper location n-tuple in the one or more qualifying location n-tuple pairs.

### CROSS-REFERENCE TO RELATED APPLICATIONS

This application claims the benefit of and priority to U.S. Provisional Patent Application Ser. No. 62/208,691 filed on Aug. 22, 2015, which application is incorporated herein by reference in its entirety.

This application is a continuation-in-part of, and claims the benefit of and priority to, U.S. Non-Provisional Patent Application Ser. No. 14/924,425 filed on Oct. 27, 2015, which application is incorporated herein by reference in its entirety.

U.S. Non-Provisional Patent Application Ser. No. 14/924,425 claims the benefit of and priority to U.S. Provisional Patent Application Ser. No. 62/073,128 filed on Oct. 31, 2014, which application is incorporated herein by reference in its entirety.

U.S. Non-Provisional Patent Application Ser. No. 14/924,425 claims the benefit of and priority to U.S. Provisional Patent Application Ser. No. 62/083,842 filed on Nov. 24, 2014, which application is incorporated herein by reference in its entirety.

U.S. Non-Provisional Patent Application Ser. No. 14/924,425 claims the benefit of and priority to U.S. Provisional Patent Application Ser. No. 62/170,095 filed on Jun. 2, 2015, which application is incorporated herein by reference in its entirety.

### BACKGROUND OF THE INVENTION

United States patent application Ser. No. 14/924,425 (“application Ser. No. 14/924,425”) teaches means for (inter alia) obtaining one or more component sequences, generating one or more location n-tuples with respect to commonly-occurring items within the component sequences, correctly placing one or more location n-tuples into a tier in a tier set, and using the tier set to identify certain common subsequences among the component sequences.

The means taught by application Ser. No. 14/924,425 include using a tier set to identify certain common subsequences among one or more component sequences, including analyzing potential common subsequences to identify those that satisfy certain conditions as to minimum length, minimum density and both minimum length and minimum density. Although such analysis may be implemented in a number of different manners, not all such implementations are equally efficient. A particularly inefficient implementation might require analysis of each and every previously-placed location n-tuple within the tier set.

Accordingly, there is a need in the art for efficient means for using a tier set to identify common sequences among two or more component sequences, including those common subsequences that satisfy certain conditions as to minimum length, minimum density and both minimum length and minimum density.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a method of identifying one or more common subsequences using a tier set. The method includes identifying one or more qualifying tier pairs in a tier set and identifying one or more pairwise combinations of location n-tuples in the qualifying tier pairs. The method also includes determining which of the identified pairwise combinations are qualifying location n-tuple pairs and determining whether a connection exists between the lower location n-tuple and the upper location n-tuple in the one or more qualifying location n-tuple pairs.

Another example embodiment includes a method of determining whether a connection exists between a lower location n-tuple and an upper location n-tuple. The method includes creating a tier cursor container and selecting either the lower location n-tuple or the upper location n-tuple as the starting location n-tuple. The method also includes adding the starting location n-tuple to the tier cursor container.

Another example embodiment includes a method of determining whether a connection exists between a lower location n-tuple and an upper location n-tuple. The method includes determining whether at least one intervening one tier exists with respect to a lower location n-tuple and a upper location n-tuple and determining whether a connection exists between the lower location n-tuple and the upper location n-tuple, if no intervening one tier exists. The method also includes identifying the lowest intervening one tier, if at least one intervening one tier exists and determining whether a connection exists between the lower location n-tuple and the one tier location n-tuple contained in the lowest intervening one tier.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a flowchart illustrating a method of identifying one or more common subsequences using a tier set;

FIG. 2 is a flowchart illustrating a method of determining whether a connection exists between a lower location n-tuple and an upper location n-tuple;

FIG. 3 is a flowchart illustrating a method of determining whether a connection exists between a lower location n-tuple and an upper location n-tuple while retaining a set of intervening location n-tuples;

FIG. 4 is a flowchart illustrating a method of determining whether a connection exists between a lower location n-tuple and an upper location n-tuple by attempting to identify an intervening one tier; and

FIG. 5 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale. Unless otherwise specifically noted, terms defined in application Ser. No. 14/924,425 have the same meanings when used herein.

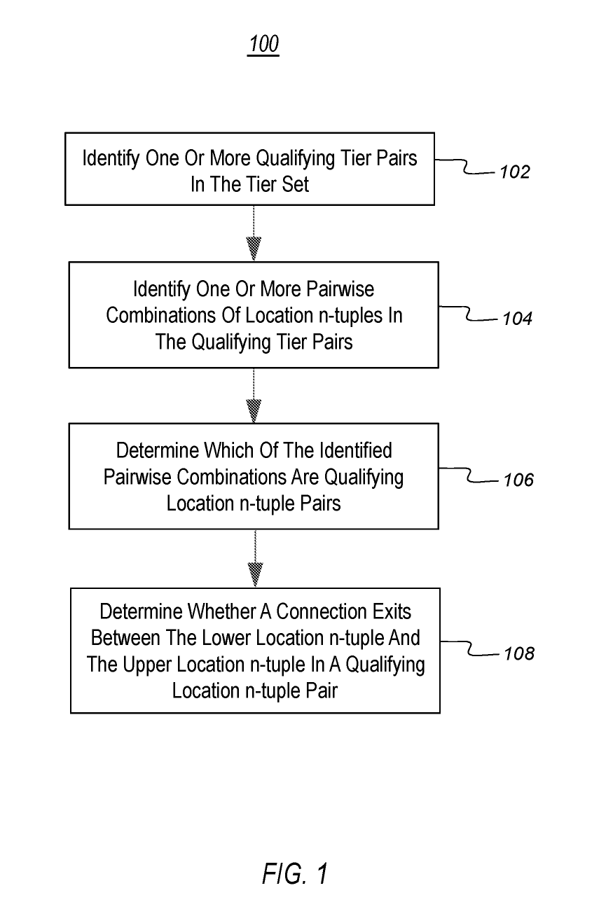

FIG. 1 is a flowchart illustrating a method 100 of identifying one or more common subsequences using a tier set.

FIG. 1 shows that the method 100 can include identifying 102 one or more qualifying tier pairs in the tier set. The qualifying tiers comprise a pairwise combination of a “lower tier” and an “upper tier” that satisfy certain requirements. For example, the requirements can include the requirement that the lower tier is before the upper tier in the tier set. A tier is “before” another tier in a tier set if it was added to the tier set before such other tier. A tier is “after” another tier in a tier set if it was added to the tier set after such other tier.

These requirements may also include a requirement regarding the minimum tier span between the lower tier and the upper tier. “Tier span” means the count of tiers from the lower tier through the upper tier (inclusive), including any tiers between the lower tier and the upper tier (each an “intervening tier”). Notationally, it can be expressed as follows: TS(tier_{lower}, tierᵤₚₚₑᵣ). A tier is “between” two other tiers in a tier set if it is after the first such other tier and before the second such other tier in the tier set.

The tier span is equal to the maximum possible length of any common subsequence(s) that begins with a location n-tuple from the lower tier and ends with a location n-tuple from the upper tier. For example, no common subsequence that begins with a location n-tuple from tier 0 and ends with a location n-tuple from tier 3 of a hypothetical tier set can exceed length 4 because this is the tier span of tier 0 and tier 3 (with tier 1 and tier 2 as the intervening tiers).

Conversely, a common subsequence of length L_{CS} may only exist if it begins and ends with location n-tuples contained, respectively, in a lower tier and an upper tier with a tier span at least equal to L_{CS}. That is, ∀ {tier_{lower}, tierᵤₚₚₑᵣ}, L_{CS}=TS(tier_{lower}, tierᵤₚₚₑᵣ)

For example, assume a hypothetical tier set consisting of six tiers. Assume also that we wish to identify a common subsequence of minimum length 5. The only qualifying tier pairs in the hypothetical tier set are as follows: 1) tier 0 and tier 5 (with tier 1, tier 2, tier 3 and tier 4 as the intervening tiers); 2) tier 0 and tier 4 (with tier 1, tier 2 and tier 3 as the intervening tiers); and 3) tier 1 and tier 5 (with tier 2, tier 3 and tier 4 as the intervening tiers).

FIG. 1 also shows that the method 100 can include identifying 104 one or more pairwise combinations of location n-tuples in the qualifying tier pairs. That is, pairs of location-tuples are identified by selecting one location n-tuple from the lower tier (each a “lower location n-tuple”) and one location n-tuple from the upper tier (each an “upper location n-tuple”) of a qualifying tier pair.

FIG. 1 further shows that the method 100 can include determining 106 which of the identified pairwise combinations are qualifying location n-tuple pairs. The one or more qualifying location n-tuple pairs are pairwise combinations of a lower location n-tuple and an upper location n-tuple that satisfy certain requirements, including the requirement that the lower location n-tuple is unambiguously smaller than the upper location n-tuple (see application Ser. No. 14/924,425 for more information regarding how to determine whether a location n-tuple is unambiguously smaller than another location n-tuple). These requirements may also include a requirement as to minimum subsequence density.

For example, consider the following tier set (“example tier set 1”):
tier 0: {{0, 1, 0}, {0, 1, 6}, {2, 0, 2}, {3, 1, 0}}
tier 1: {{1, 7, 9}, {3, 1, 6}, {4, 3, 1}}
tier 2: {{4, 3, 7}, {5, 5, 4}, {6, 4, 5}, {8, 2, 10}, {9, 8, 3}}
tier 3: {{7, 6, 8}}
tier 4: {{10, 10, 11}, {11, 9, 12}}
tier 5: {{11, 11, 12}}

Assume that the lower tier is tier 0 and the upper tier is tier 2. Assume also that the requisite minimum common subsequence density is 0.5. One potential lower and upper location n-tuple pair from this lower and upper tier pair is {0, 1, 0} from tier 0 and {4, 3, 7} from tier 2. However, this potential lower and upper location n-tuple pair does not satisfy the minimum density requirement of 0.5. Because the tier span of tier 0 and tier 2 is 3, the length of the longest common subsequence that can begin with a location n-tuple from tier 0 and end with a location n-tuple from tier 2 is 3. If a common subsequence can exist that begins with {0, 1, 0} and ends with {4, 3, 7}, its density would be 0.375=3/(7−0+1) (see application Ser. No. 14/924,425 for more information regarding common subsequence density). Because 0.375 does not satisfy the minimum density requirement of 0.5, {0, 1, 0} and {4, 3, 7} are not a qualifying location n-tuple pair. Thus, no common subsequence of minimum density 0.5 can exist with {0, 1, 0} and {4, 3, 7} as the lower and upper location n-tuples (even assuming arguendo that these location n-tuples also satisfied the connection requirements, infra, which they do not).

Another potential lower and upper location n-tuple pair from this lower and upper tier pair is {2, 0, 2} from tier 0 and {4, 3, 7} from tier 2. If a common subsequence can exist that includes {2, 0, 2} and {4, 3, 7} as the lower and upper location n-tuples, its density would be 0.5=3/(7−2+1). Because this satisfies the minimum density requirement of 0.5, {2, 0, 2} and {4, 3, 7} are a qualifying location n-tuple pair.

FIG. 1 additionally shows that the method 100 can include determining 108 whether a connection exists between the lower location n-tuple and the upper location n-tuple in a qualifying location n-tuple pair.

A “connection” exists between a lower location n-tuple and an upper location n-tuple (and such location n-tuples are said to be “connected”) if and only if all of the following requirements are satisfied (together, the “connection requirements”): 1) the lower location n-tuple is unambiguously smaller than the upper location n-tuple; and 2) if there are any intervening tiers, it is possible to select at least one location n-tuple (each an “intervening location n-tuple”) from each of the intervening tiers between the lower tier and the upper tier such that: i) each intervening location n-tuple is unambiguously larger than the lower location n-tuple; ii) each intervening location n-tuple is unambiguously smaller than the upper location n-tuple; and iii) the set of intervening location n-tuples satisfies the increasing order requirement. A location n-tuple is “unambiguously larger” than another location n-tuple if none of the component values in the first such location n-tuple is equal to the corresponding component value in the second such location n-tuple and the first such location n-tuple is not unambiguously smaller than the second such location n-tuple.

For instance, consider again example tier set 1:
tier 0: {{0, 1, 0}, {0, 1, 6}, {2, 0, 2}, {3, 1, 0}}
tier 1: {{1, 7, 9}, {3, 1, 6}, {4, 3, 1}}
tier 2: {{4, 3, 7}, {5, 5, 4}, {6, 4, 5}, {8, 2, 10}, {9, 8, 3}}
tier 3: {{7, 6, 8}}
tier 4: {{10, 10, 11}, {11, 9, 12}}
tier 5: {{11, 11, 12}}

Assume that tier 0 is the lower tier and {0, 1, 6} is the lower location n-tuple. Assume also that tier 3 is the upper tier and that {7, 6, 8} is the upper location n-tuple. No connection exists between {0, 1, 6} and {7, 6, 8} because the connection requirements cannot be satisfied. The only location n-tuple in tier 1 that is unambiguously larger than {0, 1, 6} is {1, 7, 9}. However, {1, 7, 9} is not unambiguously smaller than {7, 6, 8} because 1<7 but 7>6 and 9>8. Hence, no connection can exist between {0, 1, 6} and {7, 6, 8}.

Now, assume that {2, 0, 2} is the lower location n-tuple (and tier 0 remains the lower tier, tier 3 remains the upper tier and {7, 6, 8}0 remains the upper location n-tuple). The connection requirements may be satisfied by selecting {3, 1, 6} from tier 1 and {4, 3, 7} from tier 2. Both of these location n-tuples are unambiguously larger than {2, 0, 2} and unambiguously smaller than {7, 6, 8}. They also collectively satisfy the increasing order requirement. Hence, the following common subsequence may be identified that includes {2, 0, 2} as the lower location n-tuple and {7, 6, 8} as the upper location n-tuple: {{2, 0, 2}, {3, 1, 6}, {4, 3, 7}, {7, 6, 8}}

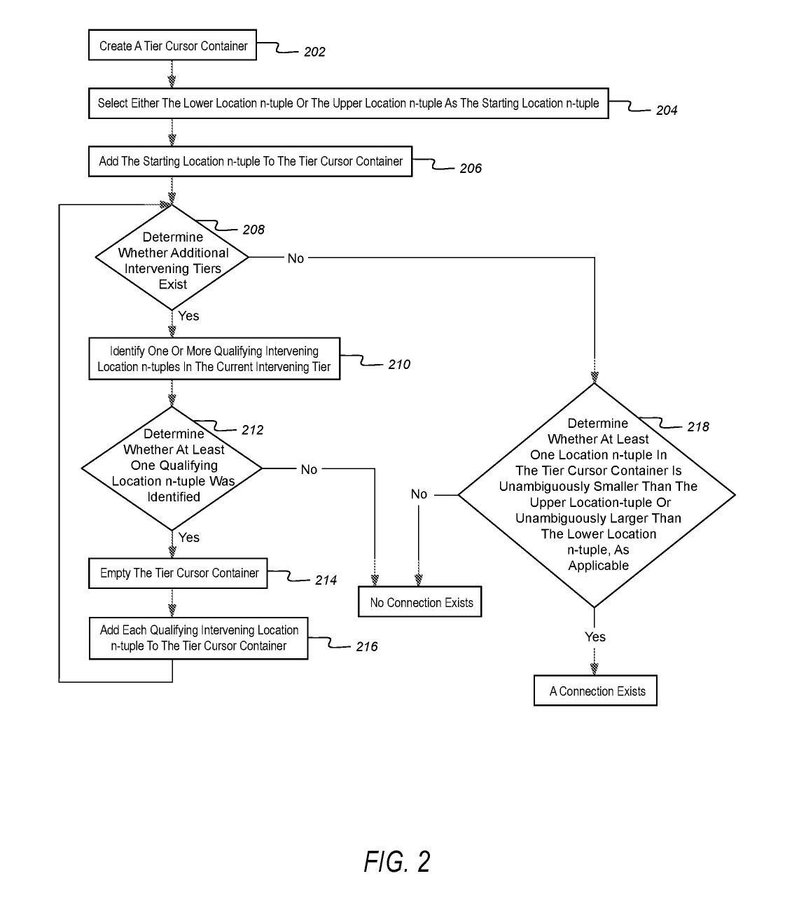

FIG. 2 is a flowchart illustrating a method 200 of determining whether a connection exists between a lower location n-tuple and an upper location n-tuple. As noted above, a connection exists whenever all of the connection requirements are satisfied.

FIG. 2 shows that the method 200 can include creating 202 a tier cursor container. A “container” is any form or combination of computer storage capable of containing one or more pieces of data and may include vectors, arrays, linked lists, queues, stacks, trees and hash tables of arbitrary size and/or number of fields or dimensions and may be ordered, unordered or partially ordered. One of skill in the art will appreciate that a container may include other containers and/or may be included within other containers.

FIG. 2 also shows that the method 200 can include selecting 204 either the lower location n-tuple or the upper location n-tuple as the starting location n-tuple. Either is acceptable, so this is a discretionary step. I.e., it does not matter whether the lower location n-tuple or the upper location n-tuple is selected, as long as the starting location n-tuple is known.

FIG. 2 further shows that the method 200 can include adding 206 the starting location n-tuple to the tier cursor container.

FIG. 2 additionally shows that the method 200 can include determining 208 whether additional intervening tiers exist. As disclosed above, intervening tiers are tiers that are between the lower tier and upper tier.

FIG. 2 moreover shows that the method 200 can include identifying 210 one or more location n-tuples in the current intervening tier (each a “qualifying intervening location n-tuple”) if additional intervening tiers exist. The identified location n-tuples must satisfy the conditions that they are: 1) unambiguously larger than the lower location n-tuple; 2) unambiguously smaller than the upper location n-tuple; and 3) either unambiguously larger than at least one location n-tuple in the tier cursor container (if the lower location n-tuple was selected as the starting location n-tuple) or unambiguously smaller than at least one location n-tuple in the tier cursor container (if the upper location n-tuple was selected as the starting location n-tuple).

The “current intervening tier” means either the initial intervening tier (upon the first iteration of 210) or the next succeeding intervening tier (upon each subsequent iteration of 210). The “initial intervening tier” means the intervening tier that is either immediately after the lower tier (if the lower location n-tuple was selected as the starting location n-tuple) or immediately before the upper tier (if the upper location n-tuple was selected as the starting location n-tuple). The “next succeeding intervening tier” means the intervening tier that is either immediately after (if the lower location n-tuple was selected as the starting location n-tuple) or immediately before (if the upper location n-tuple was selected as the starting location n-tuple) the intervening tier that was the current intervening tier at the last iteration of 210.

FIG. 2 also shows that the method 200 can include determining 212 whether at least one qualifying location n-tuple was identified 210. If no qualifying location n-tuple was identified 210, then no connection can exist between the lower location n-tuple and the upper location n-tuple.

FIG. 2 further shows that the method 200 can include emptying 214 the tier cursor container.

FIG. 2 additionally shows that the method 200 can include adding 216 each qualifying intervening location n-tuple to the tier cursor container. The steps 208-216 are repeated for each additional intervening tier until no more additional intervening tiers exist.

FIG. 2 moreover shows that the method 200 can include determining 218 whether at least one qualifying intervening location n-tuple in the tier cursor container is either unambiguously smaller than the upper location n-tuple (if the lower location n-tuple was selected as the starting location n-tuple) or unambiguously larger than the lower location n-tuple (if the upper location n-tuple was selected as the starting location n-tuple) when no additional intervening tiers exist.

Method 200 ascending order example. The operation of the method 200 may be demonstrated by the following example, which is included for illustrative purposes only and without intent or effect to limit the scope of the method 200.

Consider again example tier set 1:
tier 0: {{0, 1, 0}, {0, 1, 6}, {2, 0, 2}, {3, 1, 0}}
tier 1: {{1, 7, 9}, {3, 1, 6}, {4, 3, 1}}
tier 2: {{4, 3, 7}, {5, 5, 4}, {6, 4, 5}, {8, 2, 10}, {9, 8, 3}}
tier 3: {{7, 6, 8}}
tier 4: {{10, 10, 11}, {11, 9, 12}}
tier 5: {{11, 11, 12}}

Assume that tier 0 is the lower tier and {0, 1, 0} is the lower location n-tuple. Assume also that tier 5 is the upper tier and that {11, 11, 12} is the upper location n-tuple. Assume also that {0, 1, 0} is selected 204 as the starting location n-tuple.

The intervening tiers in this example are tier 1, tier 2, tier 3 and tier 4. Because {0, 1, 0} was selected as the starting location n-tuple, these tiers will be iterated at 208-210 in ascending order (i.e. tier 1, tier 2, tier 3 and tier 4 will each successively be the current intervening tier).

After it is first populated at 206, the tier cursor container might be depicted as follows: {{0, 1, 0}}

At the first iteration of 210, the current intervening tier is the initial intervening tier. Because the lower location n-tuple was selected as the starting location n-tuple, the initial intervening tier is tier 1. The following qualifying intervening location n-tuples are identified 210 in the current intervening tier: {1, 7, 9}, {4, 3, 1}

Because it is determined 212 that at least one qualifying intervening location n-tuple was identified 210, a connection may still exist and processing continues. After it is emptied 214 and these qualifying intervening location n-tuples are added 216 to it, the tier cursor container might be depicted as follows: {{1, 7, 9}, {4, 3, 1}}

At the next iteration of 210, the current intervening tier is the next succeeding intervening tier. Because the lower location n-tuple was selected as the starting location n-tuple, the next succeeding intervening tier is tier 2. The following qualifying intervening location n-tuples are identified 210 in the current intervening tier: {5, 5, 4}, {6, 4, 5}, {9, 8, 3}

Because it is determined 212 that at least one qualifying intervening location n-tuple was identified 210, a connection may still exist and processing continues. After it is emptied 214 and these qualifying intervening location n-tuples are added 216 to it, the tier cursor container might be depicted as follows: {{5, 5, 4}, {6, 4, 5}, {9, 8, 3}}

At the next iteration of 210, the current intervening tier is tier 3. The following qualifying intervening location n-tuples are identified 210 in the current intervening tier: {7, 6, 8}

Because it is determined 212 that at least one qualifying intervening location n-tuple was identified 210, a connection may still exist and processing continues. After it is emptied 214 and these qualifying intervening location n-tuples are added 216 to it, the tier cursor container might be depicted as follows: {{7, 6, 8}}

At the next iteration of 210, the current intervening tier is tier 4. The following qualifying intervening location n-tuples are identified 210 in the current intervening tier: {10, 10, 11}, {11, 9, 12}

Because it is determined 212 that at least one qualifying intervening location n-tuple was identified 210, a connection may still exist and processing continues. After it is emptied 214 and these qualifying intervening location n-tuples are added 216 to it, the tier cursor container might be depicted as follows: {{10, 10, 11}, {11, 9, 12}}

Because there are no remaining intervening tiers, the qualifying intervening location n-tuples in the tier cursor container are examined to determine 218 whether at least one of them is unambiguously smaller than the upper location n-tuple ({11, 11, 12}). Because {10, 10, 11} is unambiguously smaller than {11, 11, 12}, this condition is satisfied. Hence, a connection exists between the lower location n-tuple ({0, 1, 0}) and the upper location n-tuple ({11, 11, 12}).

Method 200 descending order example. The method 200 may also be applied, and the same connection between the lower location n-tuple and the upper location n-tuple established, if the intervening tiers are iterated in the opposite (i.e. descending) order. The following is included for illustrative purposes only and without intent or effect to limit the scope of the method 200. Assume all of the same facts from the method 200 ascending order example, except that {11, 11, 12} is selected 204 as the starting location n-tuple.

After it is first populated at 206, the tier cursor container might be depicted as follows: {{11, 11, 12}}

At the first iteration of 210, the current intervening tier is the initial intervening tier. Because the upper location n-tuple was selected as the starting location n-tuple, the initial intervening tier is tier 4. The following qualifying intervening location n-tuples are identified 210 in the current intervening tier: {10, 10, 11}

Because it is determined 212 that at least one qualifying intervening location n-tuple was identified 210, a connection may still exist and processing continues. After it is emptied 214 and these qualifying intervening location n-tuples are added 216 to it, the tier cursor container might be depicted as follows: {{10, 10, 11}}

At the next iteration of 210, the current intervening tier is the next succeeding intervening tier. Because the upper location n-tuple was selected as the starting location n-tuple, the next succeeding intervening tier is tier 3. The following qualifying intervening location n-tuples are identified 210 in the current intervening tier: {7, 6, 8}

Because it is determined 212 that at least one qualifying intervening location n-tuple was identified 210, a connection may still exist and processing continues. After it is emptied 214 and these qualifying intervening location n-tuples are added 216 to it, the tier cursor container might be depicted as follows: {{7, 6, 8}}

At the next iteration of 210, the current intervening tier is tier 2. The following qualifying intervening location n-tuples are identified 210 in the current intervening tier: {4, 3, 7}, {5, 5, 4}, {6, 4, 5}

Because it is determined 212 that at least one qualifying intervening location n-tuple was identified 210, a connection may still exist and processing continues. After it is emptied 214 and these qualifying intervening location n-tuples are added 216 to it, the tier cursor container might be depicted as follows: {{4, 3, 7}, {5, 5, 4}, {6, 4, 5}}

At the next iteration of 210, the current intervening tier is tier 1. The following qualifying intervening location n-tuples are identified 210 in the current intervening tier: {3, 1, 6}, {4, 3, 1}

Because it is determined 212 that at least one qualifying intervening location n-tuple was identified 210, a connection may still exist and processing continues. After it is emptied 214 and these qualifying intervening location n-tuples are added 216 to it, the tier cursor container might be depicted as follows: {{3, 1, 6}, {4, 3, 1}}

Because there are no remaining intervening tiers, the qualifying intervening location n-tuples in the tier cursor container are examined to determine 218 whether at least one of them is unambiguously larger than the lower location n-tuple ({0, 1, 0}). Because {4, 3, 1} is unambiguously larger than {0, 1, 0}, this condition is satisfied. Hence, a connection exists between the lower location n-tuple ({0, 1, 0}) and the upper location n-tuple ({11, 11, 12}).

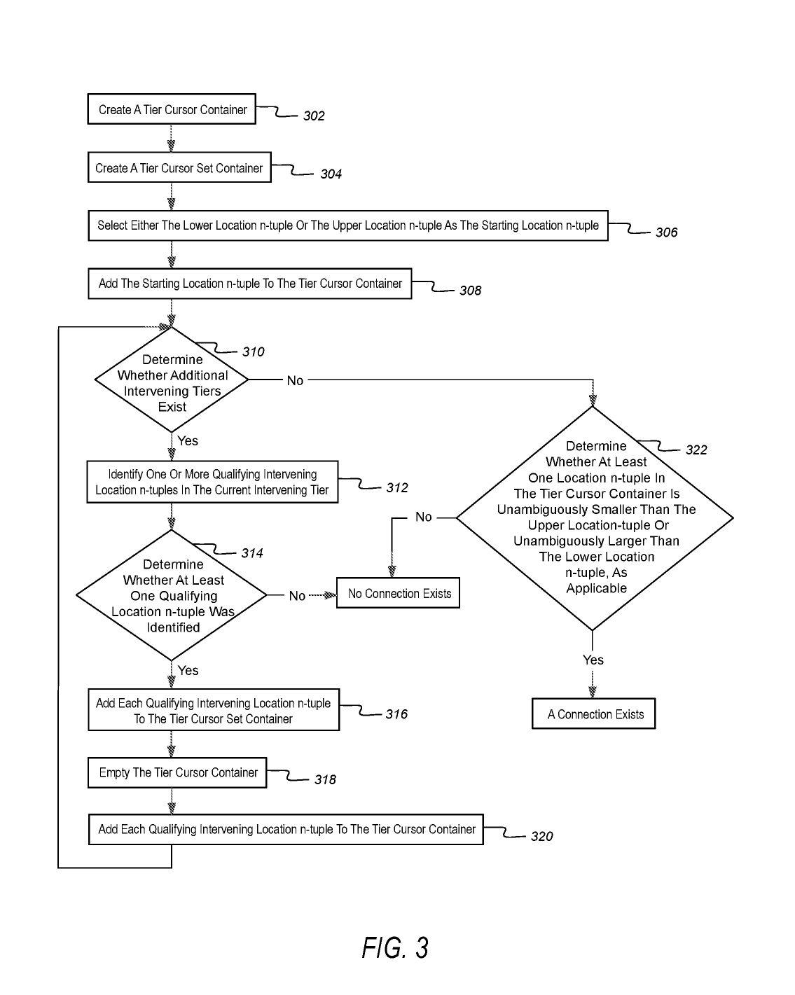

FIG. 3 is a flowchart illustrating a method 300 of determining whether a connection exists between a lower location n-tuple and an upper location n-tuple while retaining a set of intervening location n-tuples.

FIG. 3 shows that the method 300 can include creating 302 a tier cursor container.

FIG. 3 also shows that the method 300 can include creating 304 a tier cursor set container.

FIG. 3 further shows that the method 300 can include selecting 306 either the lower location n-tuple or the upper location n-tuple as the starting location n-tuple. As in the method 200 of FIG. 2, either is acceptable. I.e., it does not matter whether the lower location n-tuple or the upper location n-tuple is selected, as long as the starting location n-tuple is known.

FIG. 3 additionally shows that the method 300 can include adding 308 the starting location n-tuple to the tier cursor container.

FIG. 3 moreover shows that the method 300 can include determining 310 whether additional intervening tiers exist.

FIG. 3 also shows that the method 300 can include identifying 312 one or more qualifying intervening location n-tuples in the current intervening tier if one or more additional intervening tiers exist.

FIG. 3 further shows that the method 300 can include determining 314 whether at least one qualifying intervening location n-tuple was identified 312. If no qualifying intervening location n-tuple was identified 312, then no connection can exist between the lower location n-tuple and the upper location n-tuple.

FIG. 3 additionally shows that the method 300 can include adding 316 each of the qualifying intervening location n-tuples to the tier cursor set container if at least one qualifying location n-tuple was identified.

FIG. 3 moreover shows that the method 300 can include emptying 318 the tier cursor container.

FIG. 3 also shows that the method 300 can include adding 320 each qualifying intervening location n-tuple to the tier cursor container. The steps 310-320 are repeated for each additional intervening tier until no more additional intervening tiers exist.

FIG. 3 also shows that the method 300 can include determining 322 whether at least one qualifying intervening location n-tuple in the tier cursor container is either unambiguously smaller than the upper location n-tuple (if the lower location n-tuple was selected as the starting location n-tuple) or unambiguously larger than the lower location n-tuple (if the upper location n-tuple was selected as the starting location n-tuple) when no additional intervening tiers exist.

The operation of the method 300 may be demonstrated with the following example, which is included for illustrative purposes only and without intent or effect to limit the scope of the method 300.

Assume the same facts as in the method 200 ascending order example. The operation of the method 300 is the same, except that the qualifying intervening location n-tuples identified at each iteration of 312 are retained in the tier cursor set container. In this example, the final state of the tier cursor set container might be depicted as follows: {{{1, 7, 9}, {4, 3, 1}}, {{5, 5, 4}, {6, 4, 5}, {9, 8, 3}}, {{7, 6, 8}}, {{10, 10, 11}, {11, 9, 12}}}

The tier cursor set container may be used for additional purposes, such as recovering one or more common subsequences that begin with the lower location n-tuple and end with the upper location n-tuple (if a connection is determined to exist).

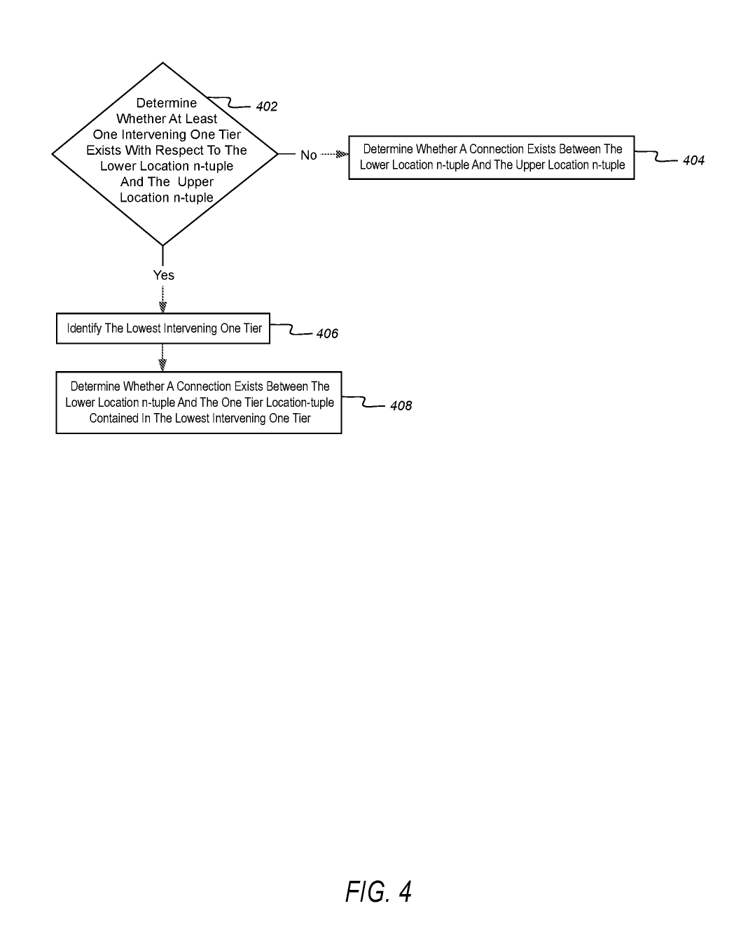

FIG. 4 is a flowchart illustrating a method 400 of determining whether a connection exists between a lower location n-tuple and an upper location n-tuple by attempting to identify an intervening one tier. A “one tier” is defined as any tier that contains precisely one location n-tuple.

A one tier possesses the useful property that the location n-tuple in it (a “one tier location n-tuple”) is necessarily connected to each location n-tuple in each tier after the one tier. That is, a pairwise connection exists between a one tier location n-tuple and each and every location n-tuple in each and every tier in a tier set that was added to the tier set after the tier that contains the one tier location n-tuple (the “one tier connectedness property”) (see application Ser. No. 14/924,425).

For instance, consider again example tier set 1:
tier 0: {{0, 1, 0}, {0, 1, 6}, {2, 0, 2}, {3, 1, 0}}
tier 1: {{1, 7, 9}, {3, 1, 6}, {4, 3, 1}}
tier 2: {{4, 3, 7}, {5, 5, 4}, {6, 4, 5}, {8, 2, 10}, {9, 8, 3}}
tier 3: {{7, 6, 8}}
tier 4: {{10, 10, 11}, {11, 9, 12}}
tier 5: {{11, 11, 12}}

Tier 3 in example tier set 1 is a one tier. Consequently, a connection necessarily exists between the one tier location n-tuple in tier 3 ({7, 6, 8}) and each and every location n-tuple in tier 4 and tier 5.

The one tier connectedness property may be explained inductively. Assume a tier set consisting of n tiers. Assume also that tier[m] is a one tier containing the location n-tuple {x, y, z} and that m<n. For the sake of simplicity, example location n-tuples comprising only three component values are discussed. However, the same analysis remains valid for any number of component values. No location n-tuple may be properly placed into tier[m+1] unless it is unambiguously larger than the location n-tuple in tier[m]. Conversely, {x, y, z} must necessarily be unambiguously smaller than every location n-tuple in tier[m+1].

Continuing the analysis, no location n-tuple may be properly placed into tier[m+2] unless it is unambiguously larger than at least one location n-tuple in tier[m+1]. Because every location n-tuple in tier[m+1] must be unambiguously larger than {x, y, z}, every location n-tuple in tier[m+2] must also be unambiguously larger than {x, y, z}. Moreover, with respect to any location n-tuple {x″, y″, z″} in tier[m+2], there must exist at least one location n-tuple {x′, y′, z′} in tier[m+1] that is both unambiguously larger than {x, y, z} and unambiguously smaller than {x″, y″, z″}. Thus, the connection requirements are satisfied because {x, y, z}<{x′, y′, z′} <{x″, y″ , z″}. The same analysis may be continued inductively for tier[m+3] through tier[n].

A useful consequence of the one tier connectedness property is that determining whether a connection exists between a lower location n-tuple and an upper location n-tuple may be simplified if intervening tiers exist between the lower tier and the upper tier and at least one of these intervening tiers is a one tier (an “intervening one tier”). Specifically, if an intervening one tier exists between the lower tier and the upper tier, then a connection necessarily exists between the lower location n-tuple and the upper location n-tuple if and only if a connection exists between the lower location n-tuple and the one tier location n-tuple contained in the intervening one tier.

For instance, consider again example tier set 1 and the exercise to determine whether a connection exists between location n-tuple {0, 1, 0} in tier 0 and location n-tuple {11, 11, 12} in tier 5. As demonstrated in the method 200 ascending order example supra, such a connection exists. However, it is possible to simplify the prior analysis by omitting consideration of tier 4 and the location n-tuples contained therein. Because tier 3 is an intervening one tier, a connection necessarily exists between the one tier location n-tuple in tier 3 ({7, 6, 8}) and each and every location n-tuple in tier 4 and tier 5. Thus, as soon as it was determined that a connection exists between {0, 1, 0} and {7, 6, 8}, it was also necessarily determined that a connection exists between {0, 1, 0} and {11, 11, 12}.

Where more than one intervening one tier exists, it is sufficient to determine whether a connection exists between the lower location n-tuple and the lowest intervening one tier. Among a set of intervening one tiers, the “lowest intervening one tier” is defined as the one tier that was added least recently to the tier set. Stated differently, the lowest intervening one tier is the one tier that was added to the tier set the soonest after the lower tier was added.

For example, consider the following tier set:
tier 0: {{0, 1, 0}, {0, 1, 6}, {2, 0, 2}, {3, 1, 0}}
tier 1: {{1, 7, 9}, {3, 1, 6}, {4, 3, 1}}
tier 2: {{4, 3, 7}, {5, 5, 4}, {6, 4, 5}, {8, 2, 10}, {9, 8, 3}}
tier 3: {{7, 6, 8}}
tier 4: {{10, 10, 11}, {11, 9, 12}}
tier 5: {{11, 11, 12}}
tier 6: {{12, 14, 14}, {13, 13, 13}}

Assume that tier 0 is the lower tier and {0, 1, 0} is the lower location n-tuple. Assume also that tier 5 is the upper tier and that {13, 13, 13} is the upper location n-tuple.

In this example, there are two intervening one tiers (tier 3 and tier 5). Because tier 3 was added to the tier set least recently, it is the lowest intervening one tier. If a connection can be identified between {0, 1, 0} land the one tier location n-tuple in either tier 3 or tier 5, this is sufficient to establish a connection between {0, 1, 0} and {13, 13, 14}. However, a connection between {0, 1, 0} and the one tier location n-tuple in tier 3 ({7, 6, 8}) necessarily implies a connection between {0, 1, 0} and the one tier location n-tuple in tier 5 ({11, 11, 12}). This is because a one tier location n-tuple is necessarily connected to each location n-tuple in each tier after the one tier containing such one tier location n-tuple, including other one tiers. Thus, determining whether a connection exists between {0, 1, 0} and {11, 11, 12} reduces to determining whether a connection exists between {0, 1, 0} and {7, 6, 8}. Moreover, because it has already been determined supa that such a connection exists, a connection also necessarily exists between {0, 1, 0} and {11, 11, 12} and between {0, 1, 0} and {13, 13, 13}.

FIG. 4 shows that the method 400 can include determining 402 whether at least one intervening one tier exists with respect to the lower location n-tuple and the upper location n-tuple.

FIG. 4 also shows that the method 400 can include determining 404 whether a connection exists between the lower location n-tuple and the upper location n-tuple when no intervening one tier exists with respect to the lower location n-tuple and the upper location n-tuple.

FIG. 4 further shows that the method 400 can include identifying 406 the lowest intervening one tier when at least one intervening one tier exists with respect to the lower location n-tuple and the upper location n-tuple.

FIG. 4 also shows that the method 400 can include determining 408 whether a connection exists between the lower location n-tuple and the one tier location n-tuple contained in the lowest intervening one tier.

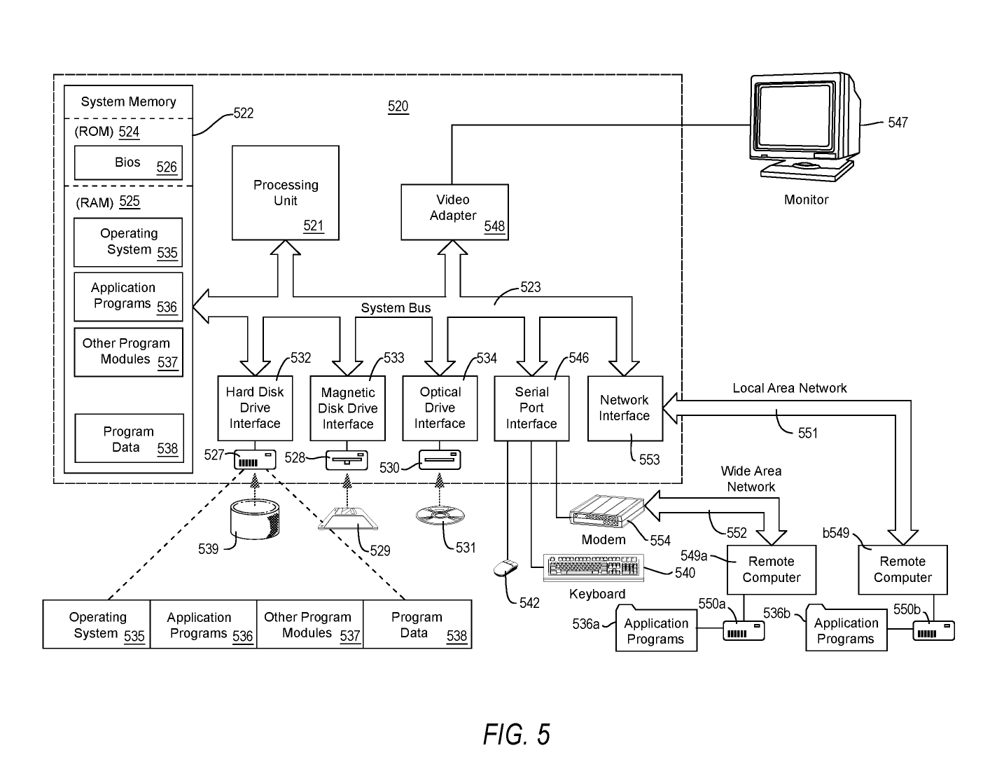

FIG. 5, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 5, an example system for implementing the invention includes a general purpose computing device in the form of a conventional computer 520, including a processing unit 521, a system memory 522, and a system bus 523 that couples various system components including the system memory 522 to the processing unit 521. It should be noted however, that as mobile phones become more sophisticated, mobile phones are beginning to incorporate many of the components illustrated for conventional computer 520. Accordingly, with relatively minor adjustments, mostly with respect to input/output devices, the description of conventional computer 520 applies equally to mobile phones. The system bus 523 may be any of several types of bus structures including a memory bus or memory controller, a peripheral bus, and a local bus using any of a variety of bus architectures. The system memory includes read only memory (ROM) 524 and random access memory (RAM) 525. A basic input/output system (BIOS) 526, containing the basic routines that help transfer information between elements within the computer 520, such as during start-up, may be stored in ROM 524.

The computer 520 may also include a magnetic hard disk drive 527 for reading from and writing to a magnetic hard disk 539, a magnetic disk drive 528 for reading from or writing to a removable magnetic disk 529, and an optical disc drive 530 for reading from or writing to removable optical disc 531 such as a CD-ROM or other optical media. The magnetic hard disk drive 527, magnetic disk drive 528, and optical disc drive 530 are connected to the system bus 523 by a hard disk drive interface 532, a magnetic disk drive-interface 533, and an optical drive interface 534, respectively. The drives and their associated computer-readable media provide nonvolatile storage of computer-executable instructions, data structures, program modules and other data for the computer 520. Although the exemplary environment described herein employs a magnetic hard disk 539, a removable magnetic disk 529 and a removable optical disc 531, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 539, magnetic disk 529, optical disc 531, ROM 524 or RAM 525, including an operating system 535, one or more application programs 536, other program modules 537, and program data 538. A user may enter commands and information into the computer 520 through keyboard 540, pointing device 542, or other input devices (not shown), such as a microphone, joy stick, game pad, satellite dish, scanner, motion detectors or the like. These and other input devices are often connected to the processing unit 521 through a serial port interface 546 coupled to system bus 523. Alternatively, the input devices may be connected by other interfaces, such as a parallel port, a game port or a universal serial bus (USB). A monitor 547 or another display device is also connected to system bus 523 via an interface, such as video adapter 548. In addition to the monitor, personal computers typically include other peripheral output devices (not shown), such as speakers and printers.

The computer 520 may operate in a networked environment using logical connections to one or more remote computers, such as remote computers 549a and 549b. Remote computers 549a and 549b may each be another personal computer, a server, a router, a network PC, a peer device or other common network node, and typically include many or all of the elements described above relative to the computer 520, although only memory storage devices 550a and 550b and their associated application programs 536a and 536b have been illustrated in FIG. 5. The logical connections depicted in FIG. 5 include a local area network (LAN) 551 and a wide area network (WAN) 552 that are presented here by way of example and not limitation. Such networking environments are commonplace in office-wide or enterprise-wide computer networks, intranets and the Internet.

When used in a LAN networking environment, the computer 520 can be connected to the local network 551 through a network interface or adapter 553. When used in a WAN networking environment, the computer 520 may include a modem 554, a wireless link, or other means for establishing communications over the wide area network 552, such as the Internet. The modem 554, which may be internal or external, is connected to the system bus 523 via the serial port interface 546. In a networked environment, program modules depicted relative to the computer 520, or portions thereof, may be stored in the remote memory storage device. It will be appreciated that the network connections shown are exemplary and other means of establishing communications over wide area network 552 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of identifying one or more common subsequences using a tier set, the method comprising:
identifying one or more qualifying tier pairs in a tier set;
identifying one or more pairwise combinations of location n-tuples in the qualifying tier pairs;
determining which of the identified pairwise combinations are qualifying location n-tuple pairs; and
determining whether a connection exists between the lower location n-tuple and the upper location n-tuple in the one or more qualifying location n-tuple pairs.

2. The method of claim 1, wherein identifying one or more qualifying tier pairs includes:
determining when a tier pair meets one or more requirements.

3. The method of claim 2, wherein the one or more requirements include a requirement that the first tier in the tier pair is before the second tier in the tier pair.

4. The method of claim 2, wherein the one or more requirements include a requirement regarding minimum tier span.

5. The method of claim 1, wherein identifying one or more pairwise combinations of location n-tuples in the qualifying tier pairs includes:
selecting a lower location n-tuple from the lower tier; and
selecting an upper location n-tuple from the upper tier.

6. The method of claim 1, wherein determining which of the identified pairwise combinations are qualifying location n-tuple pairs includes:
determing whether the lower location n-tuple is unambiguously smaller than the upper location n-tuple.

7. The method of claim 1, wherein determining which of the identified pairwise combinations are qualifying location n-tuple pairs includes:
determing whether the density of the qualifying location n-tuple pairs is equal to or greater than a minimum subsequence density.

8. The method of claim 1, wherein determining whether a connection exists between the lower location n-tuple and the upper location n-tuple in the one or more qualifying location n-tuple pairs includes:
when there is at least one intervening location n-tuple:
determing whether each intervening location n-tuple is unambiguously larger than the lower location n-tuple.

9. The method of claim 1, wherein determining whether a connection exists between the lower location n-tuple and the upper location n-tuple in the one or more qualifying location n-tuple pairs includes:
when there is at least one intervening location n-tuple:
determing whether each intervening location n-tuple is unambiguously smaller than the upper location n-tuple.

10. The method of claim 1, wherein determining whether a connection exists between the lower location n-tuple and the upper location n-tuple in the one or more qualifying location n-tuple pairs includes:
when there is at least one intervening location n-tuple:
determing whether the set of intervening location n-tuples satisfies the increasing order requirement.

11. A method of determining whether a connection exists between a lower location n-tuple and an upper location n-tuple, the method comprising:
creating a tier cursor container;
selecting either the lower location n-tuple or the upper location n-tuple as the starting location n-tuple; and
adding the starting location n-tuple to the tier cursor container.

12. The method of claim 11, further comprising:
adding one or more qualifying location n-tuples from each intervening tier to the tier cursor container.

13. The method of claim 12, further comprising:
when the lower location n-tuple was selected as the starting location n-tuple:
determining whether at least one qualifying intervening location n-tuple in the tier cursor container is unambiguously smaller than the upper location n-tuple; and
when the upper location n-tuple was selected as the starting location n-tuple:
determining whether at least one qualifying intervening location n-tuple in the tier cursor container is unambiguously larger than the lower location n-tuple.

14. The method of claim 12, wherein adding one or more qualifying location n-tuples from each intervening tier to the tier cursor container includes:
identifying one or more qualifying location n-tuples in the current intervening tier;
determining whether at least one qualifying location n-tuple was identified;
emptying the tier cursor container; and
adding each qualifying location n-tuple to the tier cursor container.

15. The method of claim 11, further comprising:
creating a tier cursor set container; and
adding one or more qualifying location n-tuples from each intervening tier to the tier cursor container and the tier cursor set container.

16. The method of claim 15, wherein adding one or more qualifying location n-tuples from each intervening tier to the tier cursor container and the tier cursor set container includes:
identifying one or more qualifying location n-tuples in the current intervening tier;
determining whether at least one qualifying location n-tuple was identified;
adding each qualifying location n-tuple to the tier cursor set container;
emptying the tier cursor container; and
adding each qualifying location n-tuple to the tier cursor container.

17. The method of claim 15, further comprising:
using the tier cursor set container to recover one or more valid common subsequences.

18. A method of determining whether a connection exists between a lower location n-tuple and an upper location n-tuple, the method comprising:
determining whether at least one intervening one tier exists with respect to a lower location n-tuple and a upper location n-tuple;
determining whether a connection exists between the lower location n-tuple and the upper location n-tuple, if no intervening one tier exists;
identifying the lowest intervening one tier, if at least one intervening one tier exists; and
determining whether a connection exists between the lower location n-tuple and the one tier location n-tuple contained in the lowest intervening one tier.

19. The method of claim 18, wherein determining whether a connection exists between a lower location n-tuple and an upper location n-tuple includes:
creating a tier cursor container;
selecting either the lower location n-tuple or the upper location n-tuple as the starting location n-tuple;
adding the starting location n-tuple to the tier cursor container;
adding one or more qualifying location n-tuples from each intervening tier to the tier cursor container; and
when the lower location n-tuple was selected as the starting location n-tuple:
determining whether at least one qualifying intervening location n-tuple in the tier cursor container is unambiguously smaller than the upper location n-tuple; and
when the upper n-tuple was selected as the starting location n-tuple:
determining whether at least one qualifying intervening location n-tuple in the tier cursor container is unambiguously larger than the lower location n-tuple.

20. The method of claim 18, wherein determining whether a connection exists between the lower location n-tuple and the one tier location n-tuple contained in the lowest intervening one tier includes:
creating a tier cursor container;
selecting either the lower location n-tuple or the one tier location n-tuple contained in the lowest intervening one tier as the starting location n-tuple;
adding the starting location n-tuple to the tier cursor container;
adding one or more qualifying location n-tuples from each intervening tier to the tier cursor container; and
when the lower location n-tuple was selected as the starting location n-tuple:
determining whether at least one qualifying intervening location n-tuple in the tier cursor container is unambiguously smaller than the one tier location n-tuple contained in the lowest intervening one tier; and
when the one tier location n-tuple contained in the lowest intervening one tier was selected as the starting location n-tuple:
determining whether at least one qualifying intervening location n-tuple in the tier cursor container is unambiguously larger than the lower location n-tuple.
